(19) United States
(12) Patent Application Publication
(10) Pub. No.: US 2018/0046049 A1
(43) Pub. Date: Feb. 15, 2018

(54) METHOD OF DETECTING LIQUID CRYSTAL DISPLAY PANEL YIELD

(71) Applicant: Wuhan China Star Optoelectronics Technology Co., Ltd., Wuhan City (CN)

(72) Inventor: Shaofu Yang, Wuhan City (CN)

(21) Appl. No.: 15/026,246

(22) PCT Filed: Feb. 26, 2016
(86) PCT No.: PCT/CN2016/074614

§ 371 Date: Mar. 30, 2016

(30) Foreign Application Priority Data
Jan. 21, 2016 (CN) 201610040495.X

(51) Int. Cl. G02F 1/1362; G02F 1/1335

(52) U.S. Cl. CPC G02F 1/136286; G02F 1/133514; G02F 2001/1635

(57) ABSTRACT

The present invention provides a method of detecting a liquid crystal display panel yield, and the signal lines of the same function in each liquid crystal display panel (11) are coupled to one wire (12), and the wire (12) extends to a periphery of the liquid crystal display mainboard (1) to form mainboard assembled wires (13) corresponding to all the liquid crystal display panels (11), and the respective mainboard assembled wires (13) are employed to drive the liquid crystal display mainboard (1) to detect all the liquid crystal display panels (11) at the same time. In comparison with prior art, the processes of the first cut, the thinning, the second cut and the lamination before the detection can be decreased. Thus, the time can be saved to rapidly respond the quality and the yield condition of the liquid crystal display panel for promoting the detection yield.

### FIELD OF THE INVENTION

The present invention relates to a display technology field, and more particularly to a method of detecting a liquid crystal display panel yield.

### BACKGROUND OF THE INVENTION

The LCD (Liquid Crystal Display) possesses many advantages of being ultra thin, power saved and radiation free. It has been widely utilized in, such as LCD TVs, mobile phones, Personal Digital Assistant (PDA), digital cameras, laptop screens or notebook screens, and dominates the flat panel display field.

Most of the liquid crystal displays on the present market are backlight type liquid crystal displays, which comprise a liquid crystal display panel and a backlight module. The working principle of the liquid crystal display panel is that the Liquid Crystal is injected between the Thin Film Transistor Array Substrate (TFT array substrate) and the Color Filter (CF). The light of backlight module is refracted to generate images by applying driving voltages to the two substrates for controlling the rotations of the liquid crystal molecules.

The liquid crystal display panel comprises a plurality of pixels arranged in array. Each pixel is electrically coupled to one thin film transistor (TFT), and a gate of the TFT is coupled to a horizontal scan line, and a drain is coupled to a vertical data line, and a source is coupled to a pixel electrode. The enough voltage is applied to the level scan line, and all the TFTs electrically coupled to the scan line are activated. Thus, the signal voltage on the data line can be written into the pixel to control the transmittances of liquid crystals to achieve the display effect.

In the production of the liquid crystal display, the yield needs to be detected for finding out and repairing the problems in time. When the requirement of the smart phone for liquid crystal display panel resolution gets higher and higher, the technology using the Low Temperature Poly-silicon (LTPS) to be the semiconductor material to manufacture the TFT array substrate becomes the main stream. The requirement for the yield detection of the liquid crystal display panel is raised along therewith. At present, the method of detecting the yield of the liquid crystal display panel is to detect the independent liquid crystal display panel one by one. However, the method needs assembling the large scale TFT array substrate with a plurality of liquid crystal display panel and the color filter substrate in advance to form the liquid crystal mainboard having a plurality of liquid crystal display panels. Then, after the processes of the first cut, the thinning, the second cut and the lamination, the independent liquid crystal display panel with the specific dimension is obtained. The processes are more, and the required time is longer, and the detection efficiency is lower, and the quality and the yield condition of the liquid crystal display panel cannot be rapidly responded.

### SUMMARY OF THE INVENTION

An objective of the present invention is to provide a method of detecting a liquid crystal display panel yield, which can reduce the processes, and save time, and rapidly respond the quality and the yield condition of the liquid crystal display panel for promoting the detection yield.

For realizing the aforesaid objective, the present invention provides a method of detecting a liquid crystal display panel yield, comprising steps of:

step 1, providing a liquid crystal display mainboard, and the liquid crystal display mainboard comprises a plurality of liquid crystal display panels arranged inside, and each liquid crystal display panel comprises a plurality of signal lines of different functions;

step 2, coupling the signal lines of the same function in each liquid crystal display panel to one wire, and the wire extends to a periphery of the liquid crystal display mainboard to form mainboard assembled wires corresponding to all the liquid crystal display panels;

step 3, employing the respective mainboard assembled wires to drive the liquid crystal display mainboard to detect all the liquid crystal display panels at the same time.

The liquid crystal display mainboard is constructed by a TFT array substrate corresponding to all the liquid crystal display panels and a color filter substrate.

A liquid crystal layer is sandwiched between the TFT array substrate and the color filter substrate.

The plurality of signal lines of different functions are manufactured on the TFT array substrate.

The plurality of signal lines of different functions comprise data lines employed for inputting data signals, and scan lines employed for inputting scan signals.

The step 2 specifically comprises: assembling the signal lines of the same function in each liquid crystal display panel to form liquid crystal display panel assembled wires, and the respective liquid crystal display panel assembled wires of the same function extend to the periphery of the liquid crystal display mainboard to form the corresponding mainboard assembled wires through the same wire.

The plurality of liquid crystal display panels are aligned in array in the liquid crystal display mainboard.

Two adjacent liquid crystal display panels are mutually spaced.

The present invention further provides a method of detecting a liquid crystal display panel yield, comprising steps of:

step 1, providing a liquid crystal display mainboard, and the liquid crystal display mainboard comprises a plurality of liquid crystal display panels arranged inside, and each liquid crystal display panel comprises a plurality of signal lines of different functions;

step 2, coupling the signal lines of the same function in each liquid crystal display panel to one wire, and the wire extends to a periphery of the liquid crystal display mainboard to form mainboard assembled wires corresponding to all the liquid crystal display panels;

step 3, employing the respective mainboard assembled wires to drive the liquid crystal display mainboard to detect all the liquid crystal display panels at the same time;

wherein the liquid crystal display mainboard is constructed by a TFT array substrate corresponding to all the liquid crystal display panels and a color filter substrate;

wherein the step 2 specifically comprises: assembling the signal lines of the same function in each liquid crystal display panel to form liquid crystal display panel assembled wires, and the respective liquid crystal display panel assembled wires of the same function extend to the periphery of the liquid crystal display mainboard to form the corresponding mainboard assembled wires through the same wire;

wherein the plurality of liquid crystal display panels are aligned in array in the liquid crystal display mainboard.

The benefits of the present invention are: the present invention provides a method of detecting a liquid crystal display panel yield, and the signal lines of the same function in each liquid crystal display panel are coupled to one wire, and the wire extends to a periphery of the liquid crystal display mainboard to form mainboard assembled wires corresponding to all the liquid crystal display panels, and the respective mainboard assembled wires are employed to drive the liquid crystal display mainboard to detect all the liquid crystal display panels at the same time. In comparison with prior art, the processes of the first cut, the thinning, the second cut and the lamination before the detection can be decreased. Thus, the time can be saved to rapidly respond the quality and the yield condition of the liquid crystal display panel for promoting the detection yield.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a flowchart of a method of detecting a liquid crystal display panel yield according to the present invention;

FIG. 2 is a diagram of a liquid crystal display mainboard in the method of detecting the liquid crystal display panel yield according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

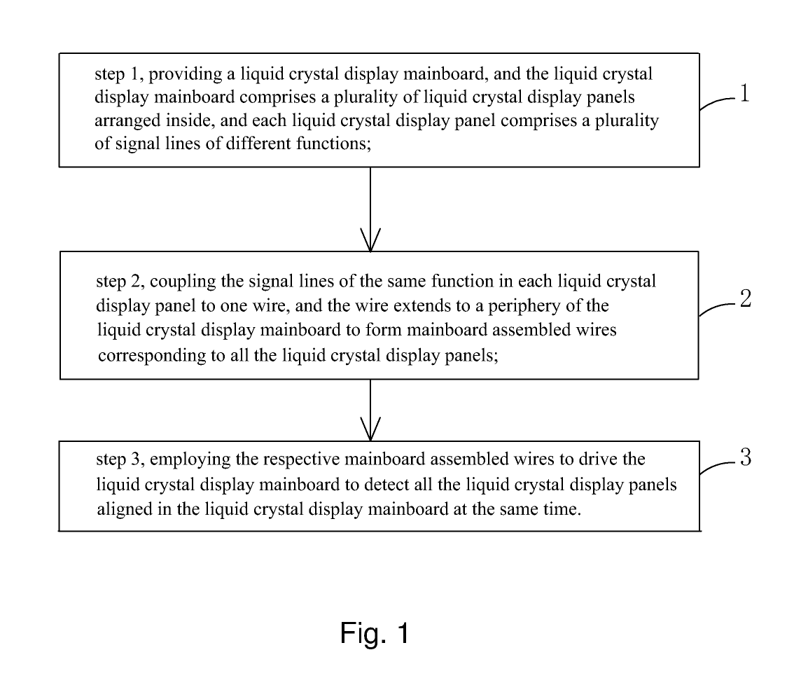

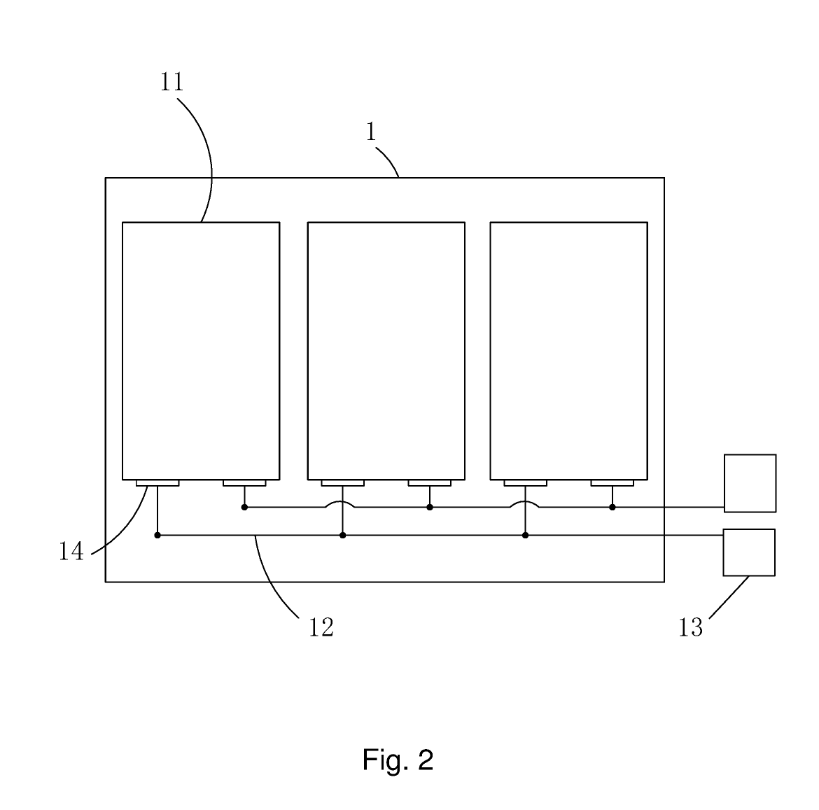

Please refer to FIG. 1 and FIG. 2 at the same time, the present invention provides a method of detecting a liquid crystal display panel yield, comprising steps of:

step 1, providing a liquid crystal display mainboard 1, and the liquid crystal display mainboard 1 comprises a plurality of liquid crystal display panels 11 arranged inside, and each liquid crystal display panel 11 comprises a plurality of signal lines of different functions.

Specifically, the plurality of liquid crystal display panels 11 are aligned in array in the liquid crystal display mainboard 1. Two adjacent liquid crystal display panels 11 are mutually spaced so that the unique liquid crystal display panel with the specific dimension can be obtained after ultimately cutting the liquid crystal display mainboard 1.

The liquid crystal display mainboard 1 is constructed by a TFT array substrate corresponding to all the liquid crystal display panels 11 and a color filter substrate. A liquid crystal layer is sandwiched between the TFT array substrate and the color filter substrate.

The plurality of signal lines of different functions are manufactured on the TFT array substrate.

The plurality of signal lines of different functions comprise data lines employed for inputting data signals, and scan lines employed for inputting scan signals.

step 2, coupling the signal lines of the same function in each liquid crystal display panel 11 to one wire 12, and the wire 12 extends to a periphery of the liquid crystal display mainboard 1 to form mainboard assembled wires 13 corresponding to all the liquid crystal display panels 11.

The step 2 specifically comprises: assembling the signal lines of the same function in each liquid crystal display panel 11 to form liquid crystal display panel assembled wires 14, and the respective liquid crystal display panel assembled wires 14 of the same function extend to the periphery of the liquid crystal display mainboard 1 to form the corresponding mainboard assembled wires 14 through the same wire 12. For instance, the data lines in each liquid crystal display panel 11 are assembled together to form the liquid crystal display panel data line assembled wires, and then the respective liquid crystal display panel data line assembled wires are coupled to the same wire, and then, the wire extends to the periphery of the liquid crystal display mainboard 1 to form the mainboard data line assembled wires; the scan lines in each liquid crystal display panel 11 are assembled together to form the liquid crystal display panel scan line assembled wires, and then the respective liquid crystal display panel scan line assembled wires are coupled to the same wire, and then, the wire extends to the periphery of the liquid crystal display mainboard 1 to form the mainboard scan line assembled wires.

step 3, employing the respective mainboard assembled wires 13 to drive the liquid crystal display mainboard 1 to detect all the liquid crystal display panels 11 aligned in the liquid crystal display mainboard 1 at the same time.

In comparison with the detection of driving the independent liquid crystal display panel one by one according to prior art, the method of detecting the liquid crystal display panel yield according to the present invention can decrease the processes of the first cut, the thinning, the second cut and the lamination before the detection. Thus, the time can be saved to rapidly respond the quality and the yield condition of the liquid crystal display panel for promoting the detection yield.

In conclusion, in the method of detecting the liquid crystal display panel yield according to the present invention, the signal lines of the same function in each liquid crystal display panel are coupled to one wire, and the wire extends to a periphery of the liquid crystal display mainboard to form mainboard assembled wires corresponding to all the liquid crystal display panels, and the respective mainboard assembled wires are employed to drive the liquid crystal display mainboard to detect all the liquid crystal display panels at the same time. In comparison with prior art, the processes of the first cut, the thinning, the second cut and the lamination before the detection can be decreased. Thus, the time can be saved to rapidly respond the quality and the yield condition of the liquid crystal display panel for promoting the detection yield.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A method of detecting a liquid crystal display panel yield, comprising steps of:
step 1, providing a liquid crystal display mainboard, and the liquid crystal display mainboard comprises a plurality of liquid crystal display panels arranged inside, and each liquid crystal display panel comprises a plurality of signal lines of different functions;
step 2, coupling the signal lines of the same function in each liquid crystal display panel to one wire, and the wire extends to a periphery of the liquid crystal display mainboard to form mainboard assembled wires corresponding to all the liquid crystal display panels;
step 3, employing the respective mainboard assembled wires to drive the liquid crystal display mainboard to detect all the liquid crystal display panels at the same time.

2. The method of detecting the liquid crystal display panel yield according to claim 1, wherein the liquid crystal display mainboard is constructed by a TFT array substrate corresponding to all the liquid crystal display panels and a color filter substrate.

3. The method of detecting the liquid crystal display panel yield according to claim 2, wherein a liquid crystal layer is sandwiched between the TFT array substrate and the color filter substrate.

4. The method of detecting the liquid crystal display panel yield according to claim 2, wherein the plurality of signal lines of different functions are manufactured on the TFT array substrate.

5. The method of detecting the liquid crystal display panel yield according to claim 4, wherein the plurality of signal lines of different functions comprise data lines employed for inputting data signals, and scan lines employed for inputting scan signals.

6. The method of detecting the liquid crystal display panel yield according to claim 1, wherein the step 2 specifically comprises: assembling the signal lines of the same function in each liquid crystal display panel to form liquid crystal display panel assembled wires, and the respective liquid crystal display panel assembled wires of the same function extend to the periphery of the liquid crystal display mainboard to form the corresponding mainboard assembled wires through the same wire.

7. The method of detecting the liquid crystal display panel yield according to claim 1, wherein the plurality of liquid crystal display panels are aligned in array in the liquid crystal display mainboard.

8. The method of detecting the liquid crystal display panel yield according to claim 7, wherein two adjacent liquid crystal display panels are mutually spaced.

9. A method of detecting a liquid crystal display panel yield, comprising steps of:
step 1, providing a liquid crystal display mainboard, and the liquid crystal display mainboard comprises a plurality of liquid crystal display panels arranged inside, and each liquid crystal display panel comprises a plurality of signal lines of different functions;
step 2, coupling the signal lines of the same function in each liquid crystal display panel to one wire, and the wire extends to a periphery of the liquid crystal display mainboard to form mainboard assembled wires corresponding to all the liquid crystal display panels;
step 3, employing the respective mainboard assembled wires to drive the liquid crystal display mainboard to detect all the liquid crystal display panels at the same time;
wherein the liquid crystal display mainboard is constructed by a TFT array substrate corresponding to all the liquid crystal display panels and a color filter substrate;
wherein the step 2 specifically comprises: assembling the signal lines of the same function in each liquid crystal display panel to form liquid crystal display panel assembled wires, and the respective liquid crystal display panel assembled wires of the same function extend to the periphery of the liquid crystal display mainboard to form the corresponding mainboard assembled wires through the same wire;
wherein the plurality of liquid crystal display panels are aligned in array in the liquid crystal display mainboard.

10. The method of detecting the liquid crystal display panel yield according to claim 9, wherein a liquid crystal layer is sandwiched between the TFT array substrate and the color filter substrate.

11. The method of detecting the liquid crystal display panel yield according to claim 9, wherein the plurality of signal lines of different functions are manufactured on the TFT array substrate.

12. The method of detecting the liquid crystal display panel yield according to claim 11, wherein the plurality of signal lines of different functions comprise data lines employed for inputting data signals, and scan lines employed for inputting scan signals.

13. The method of detecting the liquid crystal display panel yield according to claim 9, wherein two adjacent liquid crystal display panels are mutually spaced.
